(19) United States
(12) Patent Application Publication
(10) Pub. No.: US 2003/0039433 A1
(43) Pub. Date: Feb. 27, 2003

(54) Optical communication circuit

(76) Inventors: Kai Y. Eng, Atlantic Highlands, NJ (US); Jon Anderson, Brielle, NJ (US)

Correspondence Address: KAPLAN & GILMAN , L.L.P., 900NROUTE 9 NORTH, WOODBRIDGE, NJ, 07095, US

(21) Appl. No.: 09/933,460

(22) Filed: Aug. 21, 2001

(51) Int. Cl. G02B 6/28; G02B 6/35; H04B 10/20

(52) U.S. Cl. 385/24; 385/16; 359/119; 359/173

(57) ABSTRACT

An improved optical communication circuit is disclosed which is capable of overcoming a damaged link and maintaining communication. The circuit is in the form of a ring with links connecting between nodes, and the circuit includes the ability to detect a failure and to re-route a message around a break by reconfiguring the message at a modified wavelength and forwarding on a different path.

### FIELD OF THE INVENTION

The present invention relates to the field of communication by transmission of optical signals and more particularly to a method and apparatus for delivery of a message that initially failed because of a discontinuous optical circuit. In a more general embodiment, the present invention relates to a flexible and configurable optical switching and routing apparatus.

### BACKGROUND OF THE INVENTION

Optical signals form the basis of a reliable and efficient communication system. Communication, particularly digital optical signal communication is efficient and flexible. Optical signals have greater bandwidth available, thus greater communication capacity, than electrical signals for communication purposes. Therefore, optical signal transmission is quickly and strongly surpassing electrical signal transmission for communication systems.

Optical digital communication signals are typically generated by lasers which project a beam into an optical fiber that has a cladding with a relatively high index of refraction. Many optical signals, propagated at different wavelengths, may be transmitted through a single cable simultaneously, and each wavelength can transmit a distinctive message.

However, a major drawback of optical cables has been that the fibers, made of fine fiberglass, tend to be damaged easily, causing a disruption in communication. While protection switching paths can be provided, the provision of protection switching requires a tradeoff because to build a protection or backup path for each active path would require that half of the capacity of the network is wasted during normal operation.

It is an object of the invention to create an optical switching and routing arrangement that recovers from faults rapidly and efficiently without having to keep excessive extra fibers.

It is another object of the invention to provide an optical switching and routing arrangement that can operate without an excessive number of additional fibers.

### SUMMARY OF THE INVENTION

The present invention provides an apparatus and method for the rerouting of a message transmitted via an optical circuit communication link through an alternate continuous link such that any interruption of communication is kept to a minimum time.

The invention provides an optical communication circuit that is adapted for diverting to an alternate route a message that has become blocked because of a discontinuous fiber cable link. The circuit includes a controller which is programmed to determine a communication discontinuity by non-receipt of a delivery confirmation signal, followed by identification of an available wavelength in an alternate link, converted to the revised wavelength by a tunable transponder, and then re-routed to its intended destination via the alternate link.

In a more general embodiment of the invention, the arrangement implements the following method: First, it is determined that a break in communications has occurred. Then, incoming data previously destined for the now faulty optical fiber is switched to a new wavelength, while substantially simultaneously switching the physical path on which the new wavelength is output to a different fiber. The combination of switching the physical output path and switching the wavelength allows a backup path to be utilized.

The wavelength may be switched by using a tunable transponder, or in other embodiments the wavelength may be switched by using a different transponder fixedly tuned to a different wavelength.

The foregoing and other advantages of the present invention will become apparent from examining the following description of the drawings and preferred embodiments of the invention.

### BRIEF DESCRIPTION OF THE DRAWINGS

FIG. 1A is a schematic depiction of an optical communication circuit according to the present invention in which four communication nodes are connected by eight cable links.

FIG. 1B is a schematic depiction of the communication circuit of FIG. 1A and wherein two of the cable links are damaged.

FIG. 2 is an enlarged detailed diagrammatic representation of a node of the circuit of FIG. 1A.

### DETAILED DESCRIPTION OF THE INVENTION

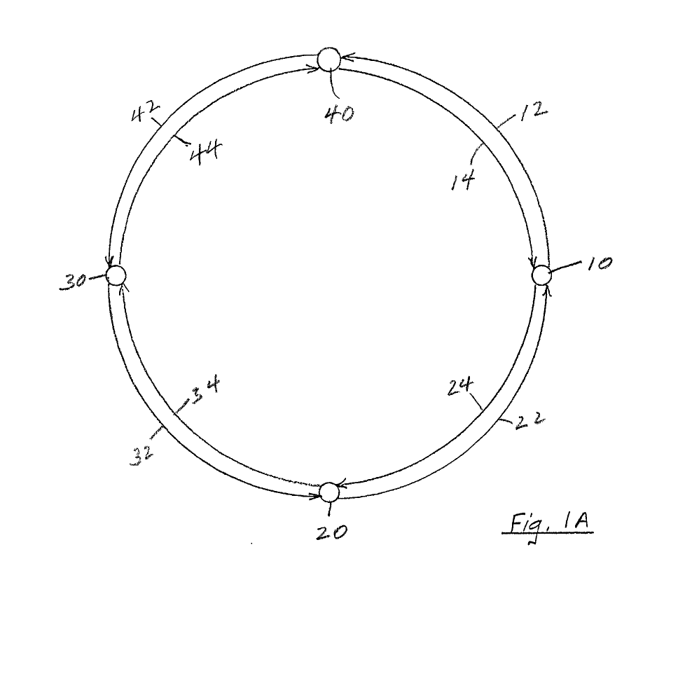

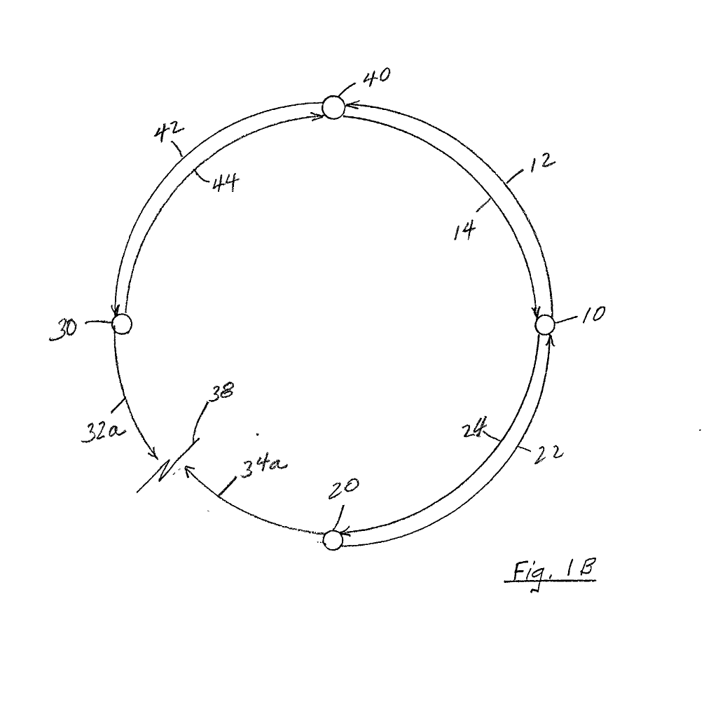

As shown in FIG. 1A, a communication circuit is presented in which nodes 10, 20, 30 and 40 are represented as stations for transmission of messages in optical form. Although illustrated as being substantially uniformly spaced, in actual practice nodes are typically separated from each other by varying distances. Cable link 24 connects node 10 to node 20 so as to convey messages thereto, and cable link 22 transmits messages from node 20 to node 10. Similarly, links 12 and 14 transmit messages between node 10 and node 40; links 32 and 34 transmit messages between node 20 and node 30; and links 42 and 44 transmit messages between node 30 and node 40. The cable links are formed of transparent glass fibers and are capable of transmitting electromagnetic radiation in many wavelengths.

Thus, by selecting the links, the communication circuit illustrated in FIG. 1A is able to transmit communications between any of the four nodes 10, 20, 30 and 40 in a clockwise or counterclockwise direction as depicted. If a message is intended to be transmitted, e.g., from node 20 to node 30, the message is sent along link 34 as a shortest available path. If the message is to go from node 20 to node 40, the message may be sent clockwise along links 34 and 44, or, alternately counterclockwise along links 22 and 12. If the message is being transmitted from node 20 to node 10, it is sent along link 22. A communication circuit having a greater number of nodes would work similarly, with additional permutations of link routing possible for different origin and destination nodes. A provisioning computer (not shown) is in communication with each of nodes 10, 20, 30 and 40 to manage message transmission and routing through control of the nodes, as will be described below.

Referring now to FIG. 1B, the communication circuit of FIG. 1A is illustrated as having sustained a break 38, causing link 32a and link 34a to be discontinuous. Pursuant to the occurrence of break 38, messages cannot be transmitted directly between node 20 and node 30, causing a message being sent in either direction between node 20 and node 30 to be undelivered. However, according to the invention disclosed herein, an alternate route is available for delivering a message from one node to another, e.g., from node 20 through nodes 10 and 40, to node 30.

Under normal conditions each node 10-40 sends a signal to the provisioning computer that a message has been generated (or has arrived from a different node) and has been forwarded to a next sequential node. Each message or packet contains a distinctive header segment that is used for identification. If the controller receives a signal, e.g. from node 20, that a specific identified message has been received and forwarded to node 30, but the computer does not subsequently receive a message that node 30 has received the sent message, the computer is alerted that link 32-34 is open. As will be understood by those skilled in the art, the lack of confirmation of receipt could result from a break only in link 34a, but it is more likely that both links 32a and 34a would be simultaneously damaged, which is fatal to delivery of a message in either direction.

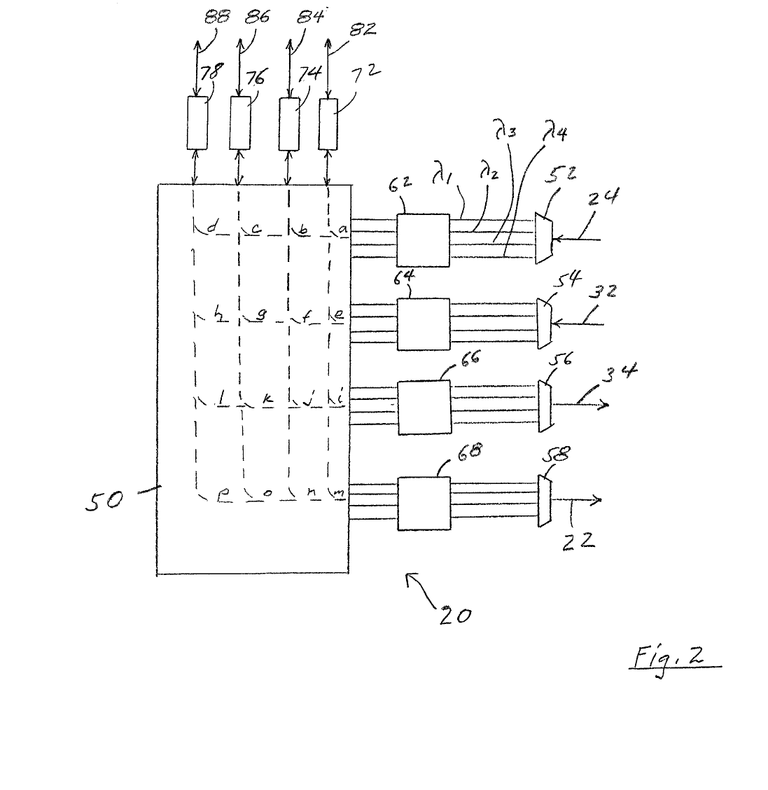

Referring now to FIG. 2, a typical node 20 of the invention is illustrated in enlarged schematic view. According to the illustration, node 20 is connected to communication links 22 and 24 as a first cable pair connected to node 10, and to links 32 and 34 as a second cable pair connected to node 30. In addition, node 20 is connected to receive messages from and send messages to an external network, e.g. a wide area network (WAN), via connectors 82, 84, 86 and 88. Links 22 and 32 are designated to transmit messages in a counterclockwise direction, as illustrated in FIG. 1A, and links 24 and 34 transmit in a clockwise direction. In practice, a link can be used in either direction, but a single link only operates to transmit messages in a single direction at any time.

Node 20 is an assembly of components connected in four optical series circuits for the transmission of optical signals. A typical set of serial components, e.g. those in communication with link 24, is made up of demultiplexer 52 (for an incoming message) and transceiver 62 connected through switching matrix 50 along path a to transponder 72. The use of the multiplexers and demultiplexers places plural wavelengths onto a single fiber and then separates those wavelengths for processing after transmission. This technique of transmissioner, known as wavelength division multiplexing (WDM) is well known in the art. Multiplexers 56 and 58 (for outgoing messages) serve to integrate signals at varied wavelengths into a common cable link, and demultiplexers 52 and 54 serve to divide the signals as they exit a fiber cable transmission link.

Transceivers 62-68, according to the embodiment of the invention, maintain the messages in their separate paths between multiplexers/demultiplexers 52-58 and switching matrix 50. It is noted that single arrows 22, 24, 26 and 28 are used to represent that the message transmission along respective links between nodes is contained in a single cable carrying a single beam of electromagnetic energy, although comprised of multiple distinct wavelengths. As divided into its multiple wavelengths, four message lines, identified as wavelengths λ₁, λ₂, λ₃ and λ₄, are shown entering transceiver 62 from demultiplexer 52. Signals λ₁-λ₄ arrive on link 24 as a single WDM signal. Demultiplexer 52 separates the WDM signal into its component wavelengths, and sends the four separate component wavelengths, λ₁-λ₄, to transceiver 62. Transciever 62 regenerates the four signals represented by λ₁-λ₄ onto four preselected wavelengths for input to switching matrix 50. The preselected wavelengths may optionally be the same wavelengths as λ₁-λ₄.

One or more of the four exemplary wavelengths is reserved for spare capacity or emergency use. In an actual system where larger numbers of paths are used, a larger number of wavelengths are reserved for spare use, for example up to 50% of the possible wavelengths. For purposes of simplicity, a single line a, representing four wavelengths, connects from the four transmission wavelengths entering switching matrix 50 to connect to transponder 72. Switching matrix 50 contains apparatus for directing a message to a specified output port. Transceiver 62 operates to receive an optical signal on any of four exemplary wavelengths, λ₁, λ₂, λ₃ and λ₄, convert the signals from optical to electrical form, to amplify the electrical signal by known electrical means, and to convert the signal back to optical energy. Transceiver 62 will also rectify the form of the incoming signal to minimize any acquired distortion or noise before sending the message onward.

The wavelength conversion by transceiver 62 enables a message received by node 20 through link 24 on first wavelength λ₁ to be re-sent through a different link, e.g. link 34, at a second wavelength, e.g. λ₅. The message is transmitted from transceiver 62 through line a to transponder 72. If the message is set to go to the WAN, it connects through line 82. If the message is to go to another node, e.g. node 30, it goes through line i to transceiver 66 and out through multiplexer 56 and to link 34. Transponder 72 is also connected via lines b, c and d to each of the other transceivers 64, 66 and 68. Each transponder 72, 74, 76 and 78 is able to connect to each transceiver 62, 64, 66 and 68 via lines a-p, as shown, to enable any signal to be diverted to any equipment component.

Assuming that a message arrives at node 20 through link 24 on wavelength λ₁, upon being amplified and passed through transceiver 62 and received by transponder 72, the message signal will be transferred through transceiver 66 to multiplexer 56 to exit through cable 34 and then to be transmitted to node 30 (see FIG. 1). If the message so transmitted is received at node 30, a receipt-confirming signal is sent from node 30 to the controller (not shown) to so indicate. However, if the cable is damaged as illustrated in FIG. 1B, the message sent from node 20 does not reach node 30, and no confirming signal goes to the provisioning computer. The computer thus determines that the cable has a break 38 and immediately re-routes the message to travel from node 20 to node 30 circuitously by way of nodes 10 and 40.

The incoming message on line 24 through demultiplexer 52 and transceiver 62 to transponder 72 is transmitted onward according to instructions from the provisioning computer. The computer sends the message at node 20 back through link 22 to node 10, through link 12 to node 40, and through link 42 to node 30. In order for the message thus re-routed not to be confused with other messages on any of cables 22, 32 or 42, a further instruction is sent to modify the wavelength of the re-routed message to an available wavelength after amplifying and upon re-sending the message. For this reason, transponder 72 has the capacity of being tunable to a selected wavelength. Such a tunable transponder is commercially available from such sources as Nortel Networks, Agility Communications, and Bandwidth9.com. Transponder 72 will, for example, send the message received at wavelength λ₁ to be transmitted outward at wavelength λ₂ over path m to transceiver 68 and multiplexer 58 to link 22.

Therefore, as described above, the present invention provides an optical communication circuit that is capable of maintaining communication between nodes by re-routing a message when a break in a cable link occurs.

The transceivers 62, 64, 66, and 68 are available off the shelf using standard technology. Thus, when an input arrives at transceiver 68, for example, the particular port on which the input signal is transmitted is determinative of the wavelength transmitted out of the transceiver to WDM 58. The wavelength arriving therefore, on line m for example, must be on the right port and adjusted to the correct wavelength.

In a first embodiment, transponders 72, 74, 76, or 78 are of the fixed wavelength type. In such an embodiment, the switching of an output signal from a primary to a backup path requires two switching operations. Using an exemplary switching path for purposes of explanation, a primary path might enter matrix 50 from transceiver 62 on line a, be transmitted through transponder 72 and then back out line m and through transceiver 68. Upon detection of a fault however, the input a from transceiver 62 is switched by matrix 50 to a new transponder, say 76, since transponder 76 is fixedly tuned to the desired backup wavelength. Additionally, and preferably substantially simultaneously, a second switching operation switches the output of transponder 76 to a backup transceiver, say 66, so that the signal affected by the fault is switched to both a new wavelength and a new physical line substantially simultaneously.

A second technique involves utilizing tunable transponders 72, 74, 76, and 78. Upon detection of a fault, the transponder through which the undelivered signal is traveling is switched to the new designated wavelength that has been preassigned for backup use. Substantially simultaneously therewith, matrix 50 switches to a new physical path to put the backup wavelength onto the correct port. Note that in such an embodiment, the transceivers may not even be needed, since the wavelength desired to be input into the WDM mulitplexer (e.g. 58) may be transmitted by the tunable transponder.

The technique of switching to the backup wavelength and port may be accomplished therefore by either switching two physical paths through the matrix 50, as in the first embodiment, or by switching one physical path and retuning a transponder. Additionally, these techniques may be combined to suit particular systems, and the user would be permitted through a system interface to provision the switch by choosing which switching operations and retuning operations are required in order to deliver the message. It is also possible that certain faults will be backed up through two switching operations, and other faults will be backed up through a single switching operation and a retuning of a transponder to an alternate wavelength.

While the present invention is described with respect to specific embodiments thereof, it is recognized that various modifications and variations thereof may be made without departing from the scope and spirit of the invention, which is more clearly understood by reference to the claims appended hereto.

What is claimed is:

1. An optical communication circuit, comprising:
(a) a plurality of nodes;
(b) a plurality of optical links connecting between each pair of adjacent nodes with a pair of incoming links and a pair of outgoing links; and
(c) wherein the nodes are capable of receiving a signal through an incoming link at a first wavelength and forwarding the signal through an outgoing link at the first wavelength or at a second wavelength, and wherein the wavelength at which the signal is forwarded and the link over which the signal is forwarded are both switched substantially simultaneously.

2. The optical communication circuit as described in claim 1, wherein the switching occurs substantially immediately upon detection of a fault.

3. The optical communication circuit as described in claim 1, wherein each node further comprises apparatus for converting the signal from a first wavelength to a second wavelength when a break has been detected in a link of the circuit.

4. The optical communication circuit as described in claim 3, wherein the apparatus for converting the signal wavelength also amplifies the signal.

5. The optical communication circuit as described in claim 4, wherein the apparatus for converting the wavelength and amplifying the signal first transforms the signal from optical mode to electrical mode for converting and amplifying.

6. The optical communication circuit as described in claim 4, wherein the apparatus for converting the wavelength and amplifying the signal further comprises means to rectify the form of the signal.

7. The optical communication circuit as described in claim 3, wherein the apparatus for converting the signal from a first wavelength to a second wavelength comprises a transceiver.

8. A method for maintaining the transmission of an optical signal through an optical communication circuit that has sustained damage to a link thereof comprising the steps of:
(a) receiving a signal to a first node at a first wavelength;
(b) converting the signal in the first node to a second wavelength; and
(c) forwarding the converted signal at the second wavelength over a different path through a switch to its intended destination.

9. The method for maintaining the transmission of an optical signal as described in claim 8, further comprising the steps of determining the existence of a break in a link of the optical communication circuit and routing the signal to circumvent the break.

10. The optical communication circuit as described in claim 8, wherein the step of forwarding the converted signal comprises forwarding the converted signal on a different path than that on which the signal was received.

11. A method for optical communications comprising the steps of:
(a) receiving a signal that a message is being sent from a first node to a second node on a first outgoing link;
(b) determining a circuit failure by the lack of a signal confirming that the message has arrived at the second node;
(c) identifying available frequencies on a second outgoing link;
(d) converting the message to an available wavelength; and
(e) forwarding the message at the available wavelength on the second outgoing link.

12. A method for maintaining optical signal communications after a break in a cable link has been detected, comprising:
(a) identifying an alternate route for a message through a continuous link;
(b) converting the message to be transmitted to an available wavelength; and
(c) transmitting the message through the alternate route at the available wavelength.

13. The method described in claim 12, wherein the step of converting the message to be transmitted to an available wavelength comprises processing the message in a transponder and instructing the transponder of the availability of an available wavelength.

14. A method for maintaining the transmission of an optical signal through an optical communication circuit that has sustained damage to a link thereof comprising the steps of:
(a) receiving an optical signal from an incoming path at a first wavelength;
(b) converting the signal in a first node to a second wavelength; and
(c) forwarding the converted signal at the second wavelength over a different path through a switch to its intended destination.
